(19) United States
(12) Patent Application Publication
(10) Pub. No.: US 2026/0236200 A1
(43) Pub. Date: Aug. 13, 2026

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Hidetomo NAKAYAMA, Kanagawa (JP)

(73) Assignee: FUJIFILM Business Innovation Corp., Tokyo (JP)

(21) Appl. No.: 19/313,022

(22) Filed: Aug. 28, 2025

(30) Foreign Application Priority Data
Feb. 10, 2025 (JP) 2025-019885

(51) Int. Cl. G06F 3/12

(52) U.S. Cl. CPC G06F 3/122; G06F 3/1274

(57) ABSTRACT

An information processing system includes a processor configured to: receive, from a user terminal, an instruction to delete a job transmitted to an image forming apparatus through a cloud-type print service; and instruct the image forming apparatus serving as a transmission destination of the job to delete the job and image data generated based on the job that are stored in the image forming apparatus.

### CROSS-REFERENCE TO RELATED APPLICATIONS

This application is based on and claims priority under 35 USC 119 from Japanese Patent Application No. 2025-019885 filed February 10, 2025.

### BACKGROUND

### (i) Technical Field

The present disclosure relates to an information processing system and a non-transitory computer readable medium.

### (ii) Related Art

Print services have nowadays been available that enable documents registered in advance in a cloud server to be output from an image forming apparatus installed in commercial facilities and the like. This type of print service is classified into a pull type and a push type.

With the pull-type print service, a job is handed over from the cloud server to the image forming apparatus after a document output instruction has been issued. Then, a raster image is generated and an image is formed.

With the push-type print service, processing up to the raster image generation is executed by the image forming apparatus before a document output instruction is issued, and an image is formed after the document output instruction has been issued.

Examples of the related art include Japanese Unexamined Patent Application Publication No. 2020-011428.

### SUMMARY

With the push-type print service, the time required for outputting a printed material after the output instruction is reduced as compared with the pull-type print service. On the other hand, with the push-type print service, a user may not output a printed material due to a schedule change or the like. With the current system, a generated raster image and a corresponding job remain in the image forming apparatus unless the user actually accesses the image forming apparatus and performs a deletion operation. As a result, raster images and jobs remaining unused for printing may occupy a large storage area in the image forming apparatus.

Aspects of non-limiting embodiments of the present disclosure relate to reducing the occupation of a storage area by an unused job or the like compared with a case where an image forming apparatus needs to be accessed for deletion of a transmitted job or the like.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: receive, from a user terminal, an instruction to delete a job transmitted to an image forming apparatus through a cloud-type print service; and instruct the image forming apparatus serving as a transmission destination of the job to delete the job and image data generated based on the job that are stored in the image forming apparatus.

### BRIEF DESCRIPTION OF THE DRAWINGS

Exemplary embodiments of the present disclosure will be described in detail based on the following figures, wherein:

FIG. 1 is a diagram illustrating an exemplary configuration of a cloud printing system;

FIG. 2 is a diagram illustrating an example of a hardware configuration of a cloud print server;

FIG. 3 is a diagram illustrating an example of a hardware configuration of a printer;

FIG. 4 is a diagram illustrating an example of a hardware configuration of a user terminal;

FIG. 5 is a diagram illustrating an exemplary processing sequence related to registration of push printing;

FIG. 6 is a diagram illustrating an exemplary processing sequence after the registration of push printing;

FIG. 7 is a diagram illustrating an example of a job management screen displayed on the user terminal;

FIG. 8 is a diagram illustrating another example of a job management screen displayed on the user terminal;

FIG. 9 is a diagram illustrating another example of a job management screen displayed on the user terminal;

FIG. 10 is a diagram illustrating an exemplary processing sequence after registration of push printing according to a second exemplary embodiment;

FIG. 11 is a diagram illustrating an exemplary processing sequence after registration of push printing according to a third exemplary embodiment; and

FIG. 12 is a diagram illustrating an exemplary processing sequence after registration of push printing according to a fourth exemplary embodiment.

### DETAILED DESCRIPTION

Hereinafter, exemplary embodiments of the present disclosure will be described with reference to the drawings.

### First Exemplary Embodiment

### Terms

A printer is an example of an image forming apparatus that forms an image on a surface of a print medium using a recording material. As preprocessing, the printer executes processing for converting print data into a raster image.

Examples of the print medium include cut paper and roll paper.

Examples of the recording material include ink and toner.

The print data includes images and texts.

The raster image is an image in bitmap format and is an example of image data. The processing of generating the raster image is referred to as raster image processor (RIP) processing or rasterization.

A job includes a print instruction and a print job generated in response to the print instruction.

The print instruction is information for instructing a method of executing the print job. The print instruction includes a push printing instruction and a pull printing instruction. The print job is an image printing command.

Push printing is a form of a cloud-type print service. Push printing is also referred to as a push-type print service. With push printing, a printer for outputting a printed material is designated at the point when a document is uploaded to a server. Hereinafter, a printer that outputs a printed material is referred to as an execution apparatus. In the case of push printing, when a document is uploaded by a user, the server immediately delivers the document to the execution apparatus. Thus, the execution apparatus generates a raster image of the document. However, the execution apparatus does not execute printing based on the generated raster image, but stores the generated raster image in the apparatus. After receiving the instruction from the user, the execution apparatus starts printing based on the raster image.

Pull printing is a form of a cloud-type print service. Pull printing is also referred to as a pull-type print service. With pull printing, the execution apparatus is not designated at the point when a document is uploaded to a server. That is, the execution apparatus is undetermined. Thus, until the user selects the execution apparatus, the uploaded document is stored in the server and is not distributed to any printer. For example, a printer that has received an output operation for the uploaded document serves as the execution apparatus. The output operation is performed after user authentication has succeeded. The execution apparatus that has received the output operation receives a document distributed from the server, generates a raster image from the received document, and starts printing. That is, the raster image starts to be generated after the authentication. Thus, with pull printing, the waiting time until a printed material is output is longer than with push printing.

### System Configuration

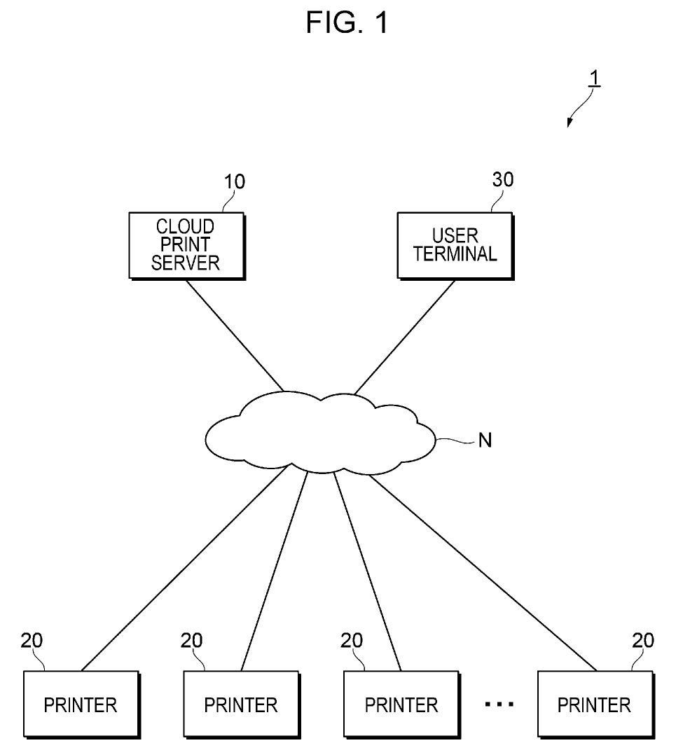

FIG. 1 is a diagram illustrating a configuration example of a cloud printing system 1.

The cloud printing system 1 includes a cloud print server 10, a plurality of printers 20, and a user terminal 30 that are connected to a cloud network N.

The cloud network N refers to the Internet used to provide a cloud-type print service. Still, the cloud network N does not need to be dedicated to a cloud-type print service. The cloud network N may be an intranet (a so-called in-house intranet) operated by a business operator or the like to which the user belongs.

The cloud print server 10 is a terminal that provides a cloud-type print service. The cloud print server 10 is an example of an information processing system.

The case of FIG. 1 includes one cloud print server 10. However, the cloud print server 10 may include a plurality of servers that cooperate with each other. The cloud print server 10 manages the status of a job uploaded from the user terminal 30.

The printer 20 is an apparatus registered in the cloud-type print service. The printer 20 according to the present exemplary embodiment is installed in a public space such as a commercial facility. Still, the installation location of the printer 20 is not limited to a public space. The plurality of printers 20 need not be manufactured by the same manufacturer and may be of any model.

One of the plurality of printers 20 is designated as the execution apparatus. In the case of push printing, the execution apparatus is designated at the point when a job is uploaded to the cloud print server 10. In the case of pull printing, the execution apparatus is determined when the output instruction is authenticated. The output instruction involves authentication. Hereinafter, the output instruction and authentication are regarded as the same.

The printer 20 according to the present exemplary embodiment is provided with a scanner function and the like in addition to a printing function. This type of printer 20 is also referred to as a multifunction peripheral. However, the printer 20 may be an apparatus dedicated to the printing function.

The user terminal 30 is a terminal operated by a user who uses the cloud print service. While FIG. 1 illustrates only one user terminal 30, the number of user terminals 30 is the same as the number of users who use the cloud-type print service. However, when the user does not use the cloud print service, the user terminal 30 is not connected to the cloud print server 10 via the cloud network N.

Note that one user may selectively use a plurality of the user terminals 30. For example, a desktop computer may be used to upload the print instruction, and a portable computer (for example, a smartphone) may be used to issue an output instruction to cause the printer 20 to output a printed material.

### Terminal Configuration

### Hardware Configuration of Cloud Print Server 10

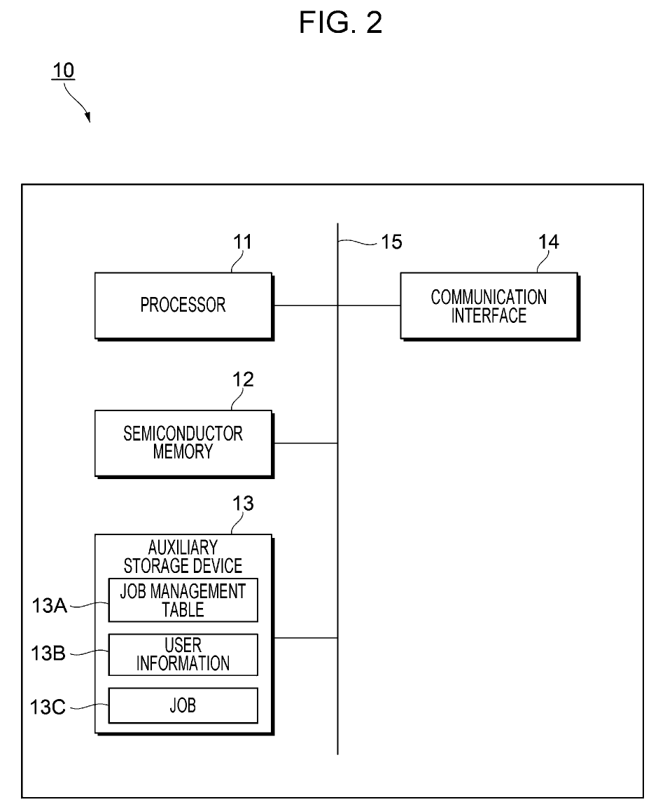

FIG. 2 is a diagram illustrating an example of a hardware configuration of the cloud print server 10.

The cloud print server 10 includes a processor 11, a semiconductor memory 12, an auxiliary storage device 13, a communication interface 14, and a signal line 15.

The processor 11 is a semiconductor integrated circuit that implements various functions by executing programs. Such programs include an operating system (OS), a unified extensible firmware interface (UEFI), and application programs.

The OS is a program for controlling the operation of the entire server. The UEFI is a program for controlling the process of starting a computer. The processor 11 according to the present exemplary embodiment manages a job of the user by executing an application program.

The semiconductor memory 12 includes, for example, a read only memory (ROM) and a random access memory (RAM) used as a work area of the processor 11.

The auxiliary storage device 13 includes, for example, a hard disk drive or a semiconductor storage. In addition to the programs, the auxiliary storage device 13 stores a job management table 13A, user information 13B, and a job 13C.

The job management table 13A manages, for example, user name, an ID of a device used for job upload and authentication, reception date and time, job ID, job name, print instruction type, output destination (that is, execution apparatus), sheet size, sheet type, print data, the number of pages, data sizes, and status. The status is information indicating, for example, whether the job is in a waiting state or has been executed. The print job includes, for example, output destination, sheet size, sheet type, print data, the number of pages, data size, and status. When the print instruction type is pull printing, the output destination is undetermined.

As the user information 13B, information on the user registered in the cloud print service is stored. The user information 13B includes, for example, user ID, user name, account ID, and password.

The job 13C is managed by using a job ID issued for each notification from the user terminal 30. As described above, the job 13C includes a print instruction and a print job.

The communication interface 14 is a module that enables communication with external terminals. The communication interface 14 includes, for example, a module used for connection to a wired or wireless local area network (LAN). The communication interface 14 further includes, for example, a universal serial bus (USB) module. The communication interface 14 is also used for communication between the printer 20 (see FIG. 1) and the user terminal 30 (see FIG. 1).

These devices are connected to each other through a bus or another signal line 15.

### Hardware Configuration of Printer 20

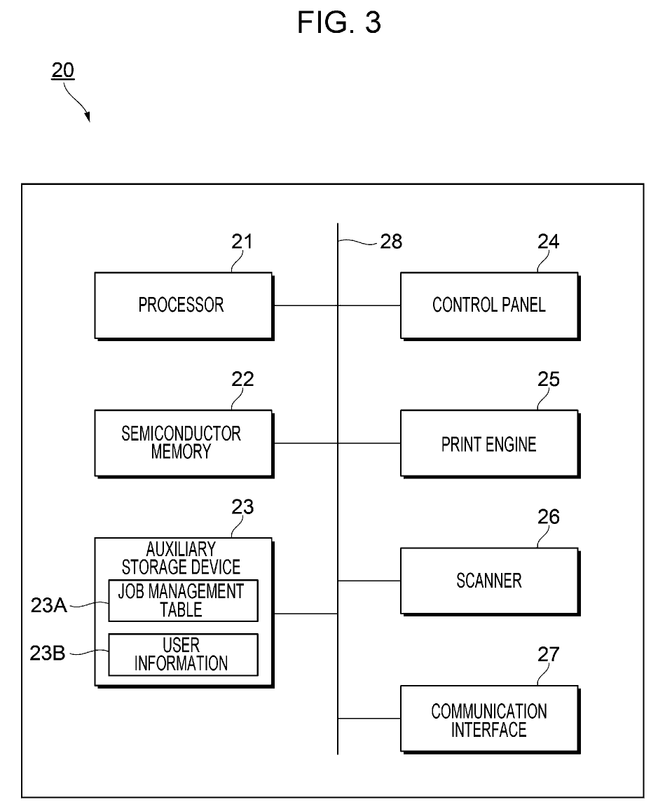

FIG. 3 is a diagram illustrating an example of a hardware configuration of the printer 20.

The printer 20 includes a processor 21, a semiconductor memory 22, an auxiliary storage device 23, a control panel 24, a print engine 25, a scanner 26, a communication interface 27, and a signal line 28.

The processor 21 is a semiconductor integrated circuit that implements various functions by executing programs. This program includes firmware, UEFI, and application programs.

The firmware is a program for controlling the operation of the entire apparatus. The UEFI is a program for controlling the process of starting a computer. By executing a program, the processor 21 according to the present exemplary embodiment executes a print job received from the cloud print server 10 (see FIG. 1).

The semiconductor memory 22 includes, for example, a ROM and a RAM used as a work area of the processor 21.

The auxiliary storage device 23 includes, for example, a hard disk drive or a semiconductor storage. In addition to the programs, the auxiliary storage device 23 stores a print instruction 23A and a print job 23B.

When the print instruction 23A is for push printing, processing up to the generation of a raster image based on the print job 23B is executed. That is, the printer 20 designated as the execution apparatus in the print job 23B suspends printing of an image based on the raster image until the cloud print server 10 notifies the printer 20 of successful authentication.

In the case of pull printing, the print instruction 23A and the print job 23B are stored in the cloud print server 10 and are not notified to the printer 20 until the user designates the printer 20 to be used as the execution apparatus. Upon receiving the print job 23B indicating pull printing, the printer 20 generates a raster image and prints an image based on the raster image.

The control panel 24 is a device that receives user operations. The control panel 24 is provided with, for example, a touch panel, buttons, and switches. The touch panel is, for example, a device having a structure in which capacitive translucent thin-film sensors are stacked on a surface of a display. The touch panel is an example of a device having functions of both an input device and an output device. The buttons and the switches are examples of mechanical operators. Hereinafter, various screens displayed on the touch panel are also referred to as operation screens.

The print engine 25 is a device that prints information on a sheet or another medium. The print engine 25 according to the present exemplary embodiment also executes various types of processing related to printing of information. For example, the print engine 25 also executes functions related to rasterization processing, density correction, sharpness correction, contrast correction, and background color removal. The mechanism of the print engine 25 varies depending on the printing method. For example, the mechanism of the print engine 25 is different for photo printing method and inkjet method.

A mechanism for transporting a medium (i.e., a transport mechanism) varies depending on whether the sheet or another medium is cut paper or roll paper.

The scanner 26 is a device that optically reads information on a surface of an original. The scanner 26 supports at least one of a method in which a reading unit is moved relative to an original not moving and a method in which an original is moved relative to a reading unit not moving.

The communication interface 27 is a module that enables communication with an external terminal. The communication interface 27 includes, for example, a module used for connection to a wired or wireless LAN. The communication interface 27 includes, for example, a USB module or a near field communication (NFC) module. The communication interface 27 is used for communication between the cloud print server 10 (see FIG. 1) and the user terminal 30 (see FIG. 1).

These devices are connected to each other through a bus or another signal line 28.

### Hardware Configuration of User Terminal 30

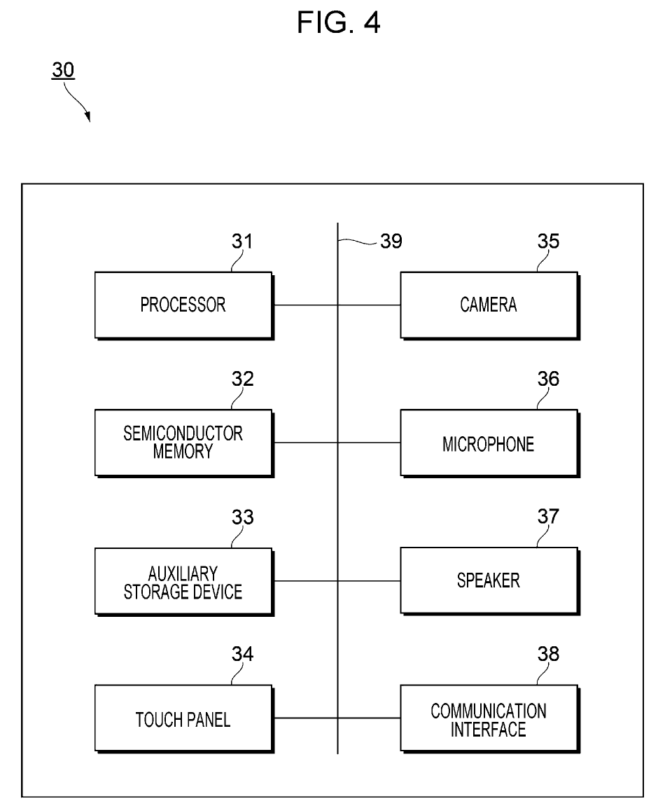

FIG. 4 is a diagram illustrating an example of a hardware configuration of the user terminal 30. The user terminal 30 illustrated in FIG. 4 is assumed to be a smartphone. The smartphone is an example of a mobile terminal. Other mobile terminals include a laptop computer and a tablet terminal.

The user terminal 30 includes a processor 31, a semiconductor memory 32, an auxiliary storage device 33, a touch panel 34, a camera 35, a microphone 36, a speaker 37, a communication interface 38, and a signal line 39.

The processor 31 is a semiconductor integrated circuit that implements various functions by executing programs. This program includes firmware, UEFI, and application programs.

The firmware is a program for controlling the operation of the entire terminal. The UEFI is a program for controlling the process of starting a computer. By executing an application program, the processor 31 according to the present exemplary embodiment executes upload of a job to the cloud print server 10 (see FIG. 1) and user authentication.

The semiconductor memory 32 includes, for example, a ROM and a RAM used as a work area of the processor 31.

The auxiliary storage device 33 includes, for example, a hard disk drive or a semiconductor storage. For example, the auxiliary storage device 33 stores print data. The hardware configuration of the auxiliary storage device 33 varies depending on whether the user terminal 30 is of a desktop type or a portable type.

The touch panel 34 includes a display serving as an output device and a capacitive translucent thin-film sensor serving as an input device. When the user terminal 30 is a desktop computer, for example, a monitor, a keyboard, and a mouse are used instead of the touch panel 34.

The camera 35 and the microphone 36 are examples of the input device, and the speaker 37 is an example of the output device.

The communication interface 38 is a module that implements communication with an external terminal. The communication interface 38 includes, for example, a module used for connection to a wired or wireless LAN. The communication interface 38 includes, for example, a USB module or a near field communication (NFC) module. The communication interface 38 is used for communication between the cloud print server 10 (see FIG. 1) and the printer 20 (see FIG. 1).

These devices are connected to each other through a bus or another signal line 39.

### Processing Sequence

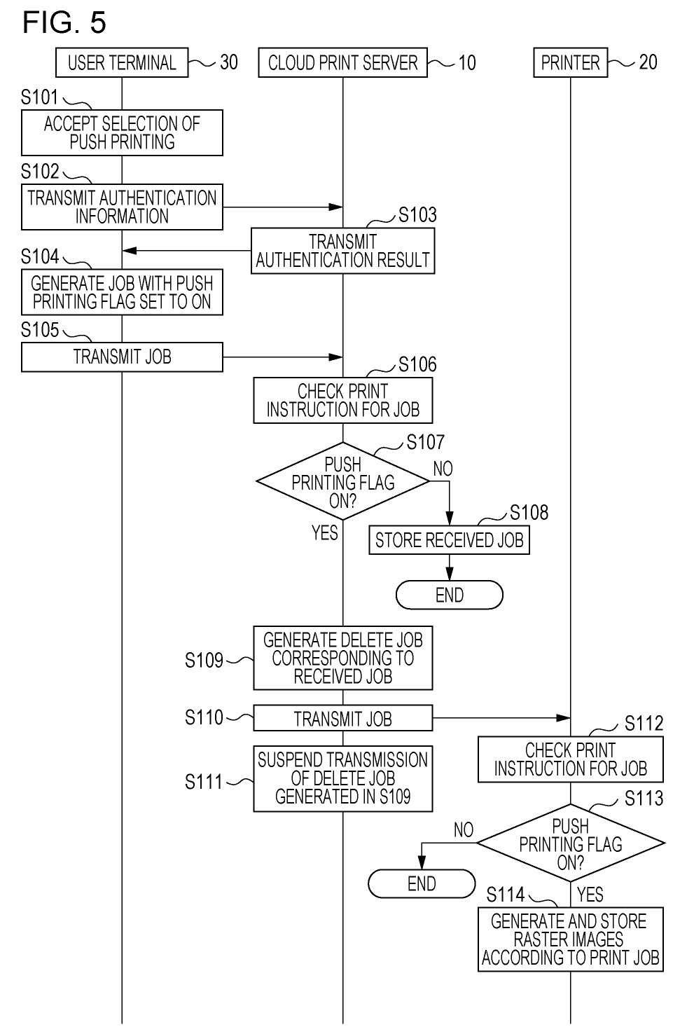

FIG. 5 is a diagram illustrating an exemplary processing sequence related to registration of push printing. The symbol S illustrated in FIG. 5 represents a step.

In the case of FIG. 5, the user terminal 30 receives a selection of push printing (step 101). Selection of push printing is received through the touch panel 34 (see FIG. 4).

Next, the user terminal 30 transmits authentication information to the cloud print server 10 (step 102). The authentication information includes, for example, an account ID and a password.

The cloud print server 10 collates the authentication information received from the user terminals 30 with the user information 13B (see FIG. 2). When the user information 13B that matches the authentication information is found, authentication is successful. When there is no user information 13B that matches the authentication information, authentication fails. The cloud print server 10 transmits a result of the authentication to the user terminal 30 (step 103). In the following description, it is assumed that authentication has succeeded.

When the authentication has succeeded, the user terminal 30 generates a job with a push printing flag set to ON (step 104). When pull printing is selected by the user, the push printing flag is set to OFF.

Next, the user terminal 30 transmits the job to the cloud print server 10 (step 105). As described above, the job includes a print instruction and a print job generated in response to the print instruction.

Upon receiving the job, the cloud print server 10 checks the print instruction for the job (step 106) and determines whether the push printing flag is ON (step 107).

When the push printing flag is OFF, a negative result is obtained in step 107. In this case, the print instruction is for pull printing. Thus, the cloud print server 10 stores the received job (step 108).

On the other hand, when the push printing flag is ON, a positive result is obtained in step 107. In this case, the print instruction is for push printing. Thus, the cloud print server 10 generates a delete job corresponding to the received job (step 109). The delete job is a job for deleting the corresponding print job.

Next, the cloud print server 10 transmits the job to the printer 20 designated as the execution apparatus (step 110). The job here includes a print instruction and a print job.

On the other hand, the cloud print server 10 suspends transmission of the delete job generated in S109 (step 111).

Upon receiving the notification of the job from the cloud print server 10, the printer 20 checks the print instruction for the job (step 112) and determines whether the push printing flag is ON (step 113).

When the push printing flag is OFF, a negative result is obtained in step 113. In this case, the print instruction is for pull printing.

In the case of pull printing, the printer 20 executes a print job included in the job received from the cloud print server 10. Specifically, the printer 20 generates a raster image from a document given as print data, and generates an image on a sheet using the generated raster image.

On the other hand, when the push printing flag is ON, a positive result is obtained in step 113. In this case, the print instruction is for push printing. Thus, the cloud print server 10 generates and stores a raster image in accordance with the print job (step 114). That is, printing of an image based on the generated raster image is suspended.

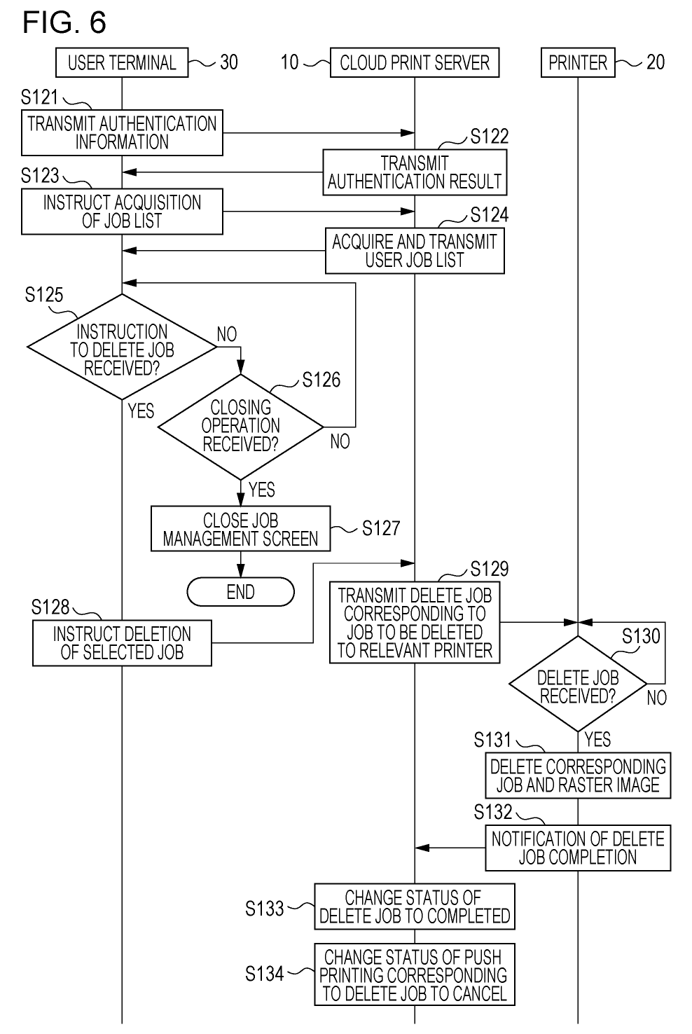

FIG. 6 is a diagram illustrating an exemplary processing sequence after the registration of push printing. The symbol S illustrated in FIG. 6 also represents a step.

The processing sequence illustrated in FIG. 6 is executed when, for example, a user who uses the cloud print service becomes unable to access the printer 20 designated as the execution apparatus or accesses the printer 20 designated as the execution apparatus. In both cases, the processing sequence illustrated in FIG. 6 is executed after a job is registered.

In the case of FIG. 6, the user terminal 30 transmits authentication information to the cloud print server 10 (step 121). The user terminal 30 used to transmit the authentication information may be the same as or different from the user terminal 30 used to transmit the authentication information in step 102 (see FIG. 5). For example, a desktop computer may be used to transmit the authentication information in step 102, and a smartphone may be used to transmit the authentication information in step 121. The same smartphone may be used to transmit the authentication information in steps 102 and 121.

Upon receiving the authentication information, the cloud print server 10 collates the authentication information received from the user terminal 30 with the user information 13B (see FIG. 2), and transmits a result of the authentication to the user terminal 30 (step 122). In the following description, it is assumed that authentication has succeeded.

When the authentication has succeeded, the user terminal 30 instructs the cloud print server 10 to acquire a job list (step 123). The job list is a list of jobs uploaded by a user successfully authenticated.

The cloud print server 10 acquires and transmits the job list of the user (step 124).

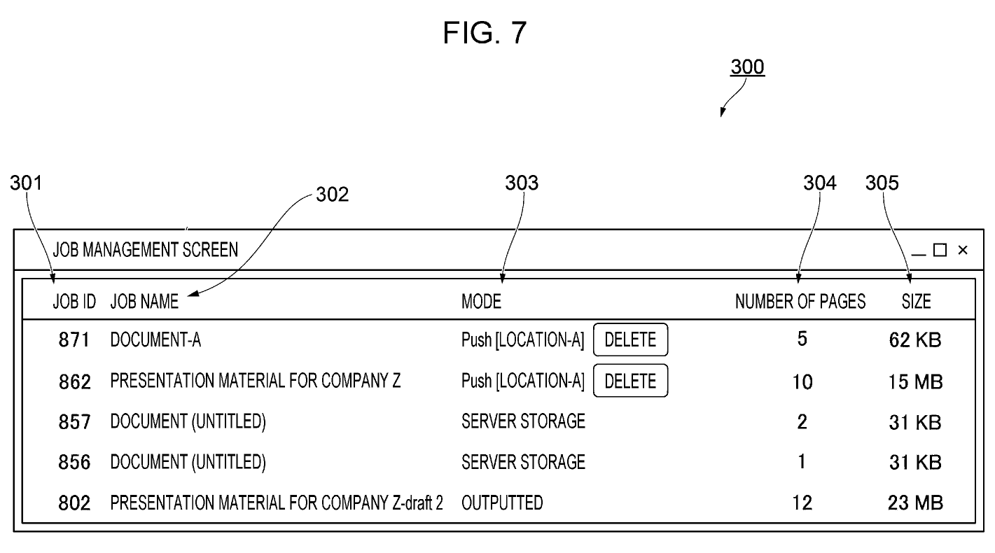

FIG. 7 is a diagram illustrating an example of a job management screen 300 displayed on the user terminal 30 (see FIG. 1). Regarding the job management screen 300 illustrated in FIG. 7, it is assumed that the user terminal 30 is a desktop computer. Thus, the job management screen 300 is displayed in a small window format. In the case of FIG. 7, the job management screen 300 has a reduced display button, an enlarged display button, and a close button arranged in the upper right part.

The job management screen 300 illustrated in FIG. 7 includes a job ID field 301, a job name field 302, a mode field 303, a number-of-pages field 304, and a size field 305.

The job ID field 301 displays a job ID. The job ID is an ID used to manage a job and is assigned, for example, when a job is received. In the case of FIG. 7, the job ID is managed by a three-digit number. Still, the number of digits of the job ID is not limited thereto. The job ID is not limited to numeric characters, and may be also denoted by other character types such as alphabetical characters.

The job name field 302 displays a job name. As the job name, for example, a file name is used.

The mode field 303 displays the content of the print instruction. In the case of FIG. 7, a job in the first row from the top indicates that the job (i.e., "document-A") corresponds to push printing and that the print location (i.e., the location where the execution apparatus is installed) is "location-A". In the case of FIG. 7, a job in the third row from the top (i.e., "document (untitled)") indicates "server storage" corresponding to pull printing.

With reference to FIG. 7, a job in the fifth row from the top (i.e., "presentation material for company Z-draft 2") indicates outputted. In the present exemplary embodiment, the job management screen 300 displays not only information of jobs waiting to be executed but also information of executed jobs.

For push printing that is waiting to be executed, a "delete" button 303A is displayed. When the delete job is executed or when a job has been executed (i.e., "outputted"), the "delete" button 303A is removed from the screen.

Upon receiving an operation on the "delete" button 303A, the cloud print server 10 instructs the corresponding execution apparatus to delete the stored data (for example, a raster image) related to the job. Upon receiving an operation on the "delete" button 303A, the cloud print server 10 deletes the relevant job from the job management table 13A (see FIG. 2) after deleting the job in the execution apparatus. The deleted job is moved to a deletion log.

The number-of-pages field 304 indicates the number of sheets to be output when the print job is executed.

The size field 305 indicates the file size of a job or print job.

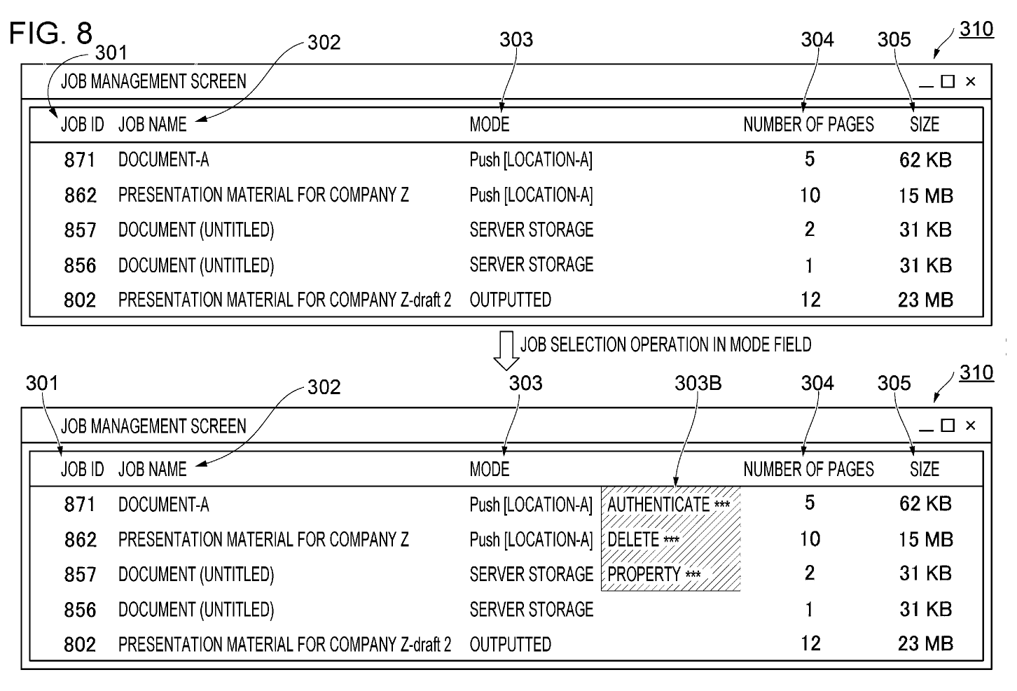

FIG. 8 is a diagram illustrating another example of a job management screen 310 displayed on the user terminal 30 (see FIG. 1). In FIG. 8, parts corresponding to those in FIG. 7 are denoted by the same reference numerals.

Like the job management screen 300 illustrated in FIG. 7, the job management screen 310 illustrated in FIG. 8 also assumes a case where the user terminal 30 is a desktop computer.

Unlike the job management screen 300 illustrated in FIG. 7, the "delete" button 303A is not displayed on the job management screen 310 illustrated in FIG. 8.

When a job corresponding to push printing is selected on the screen, a pull-down menu 303B is displayed in the mode field 303.

The pull-down menu 303B includes a plurality of items. In the case of FIG. 8, three items of "authenticate", "delete", and "property" are included.

When "delete" is operated, as described above, the execution apparatus is instructed to delete the relevant job. After the deletion of the job in the execution apparatus, the target job is deleted from the job management table 13A (see FIG. 2).

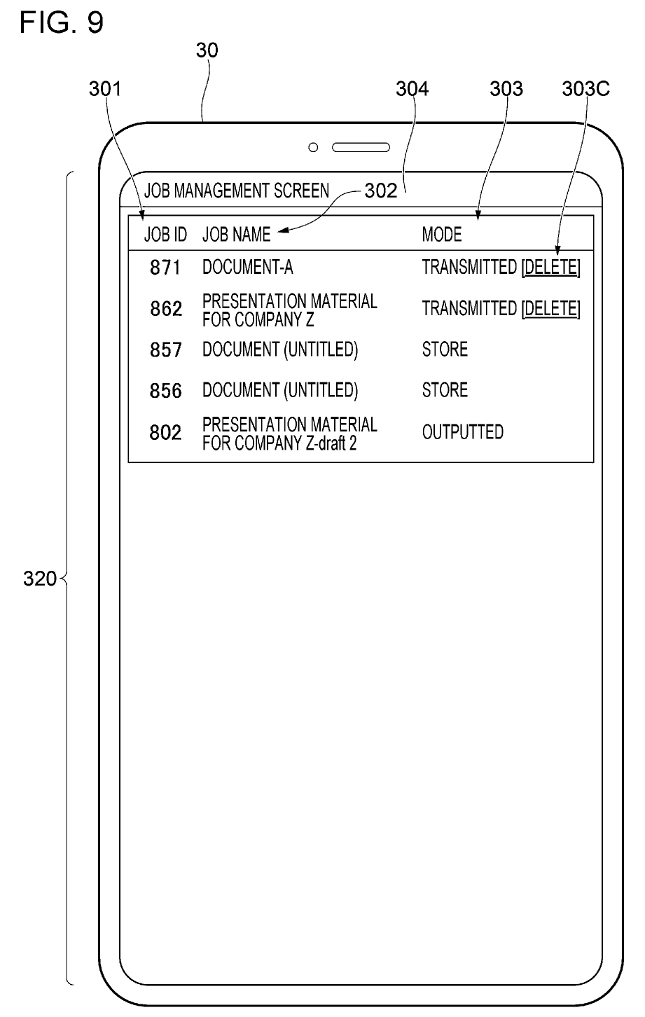

FIG. 9 is a diagram illustrating another example of a job management screen 320 displayed on the user terminal 30. In FIG. 9, parts corresponding to those in FIG. 7 are denoted by the same reference numerals.

The job management screen 320 illustrated in FIG. 9 assumes a case where the user terminal 30 is a smartphone.

The job management screen 320 illustrated in FIG. 9 is provided with the job ID field 301, the job name field 302, and the mode field 303. When a smartphone is used, the job management screen 320 is displayed in a portrait layout. For this reason, the job management screen 320 illustrated in FIG. 9 does not include the number-of-pages field 304 (see FIG. 7) or the size field 305 (see FIG. 7).

In the case of the job management screen 320 illustrated in FIG. 9, the display format of the mode field 303 is different from that of the job management screen 300 (see FIG. 7) or the job management screen 310 (see FIG. 8) described above.

For example, the fact that push printing is performed is indicated by the description "transmitted". This "transmitted" means that the job has been transmitted to the execution apparatus. Due to the limited screen size, the installation location of the execution apparatus is not displayed.

Still, a format may be employed where information of the installation location is displayed on the screen when a job is selected. When a plurality of the printers 20 are installed at a single installation location, information identifying the printers 20 may also be displayed.

A character string "delete" 303C has an embedded hyperlink. When the character string "delete" 303C is tapped, a macro is activated to give an instruction to delete a job stored in the cloud print server 10 (see FIG. 1) or the printer 20 (see FIG. 1).

In the mode field 303, "store" is displayed to indicate that pull printing is performed. As in the case of the job management screen 300 (see FIG. 7), "server storage" may be displayed.

The description is given referring back to FIG. 6.

The user terminal 30 determines whether an instruction to delete a job has been received on the job management screen 300 or the like (step 125).

When no operation has been received or when an operation other than the deletion instruction has been received, a negative result is obtained in step 125. In this case, the user terminal 30 determines whether a close operation has been received (step 126).

When the operation is not the close operation, a negative result is obtained in step 126. In this case, the user terminal 30 returns to the determination processing in step 125.

When the operation is the close operation, a positive result is obtained in step 125. In this case, the user terminal 30 closes the job management screen 300 or the like (step 127).

When the received instruction is the job deletion instruction, a positive result is obtained in step 126. In this case, the user terminal 30 instructs the cloud print server 10 to delete the selected job (step 128).

The cloud print server 10 transmits a delete job corresponding to the job to be deleted to the relevant printer 20 (that is, the execution apparatus) (step 129).

The printer 20 determines whether the delete job has been received (step 130). This determination is constantly executed in the background, for example. Alternatively, whether the delete job is received until the execution timing may be determined at a predetermined timing (for example, at regular intervals or at a predetermined time).

That is, the determination of whether the delete job has been received may not be executed simultaneously with the reception of the delete job.

The delete job according to the present exemplary embodiment is intended to prevent a job that is no longer scheduled to be executed from remaining to be stored in the printer 20. Therefore, there may be a time difference between the timing when a delete job is received and the timing when a corresponding job or the like is deleted.

When the delete job is not received, a negative result is obtained in step 130. In this case, the printer 20 repeats the determination in step 130.

On the other hand, when the delete job is received, a positive result is obtained in step 130. In this case, the printer 20 deletes the corresponding job and raster image (step 131). As a result, the unoccupied area of the auxiliary storage device 23 increases. For example, when "document-A" (see FIG. 7) is deleted, at least 62 KB of data is deleted.

Next, the printer 20 notifies the cloud print server 10 of the completion of the delete job (step 132).

Upon receiving the notification of the completion of the delete job, the cloud print server 10 changes the status of the delete job to completed (step 133) and changes the status of the push printing corresponding to the delete job to cancel (step 134). The push printing job 13C (see FIG. 2) whose status has been changed to cancel is deleted from the auxiliary storage device 13 (see FIG. 2).

When the push printing job is deleted, the cloud print server 10 deletes the corresponding job from the management target. In other words, the cloud print server 10 excludes the corresponding job from the management of jobs waiting to be executed and executed jobs. The deleted push printing job is managed by the deletion log.

### Summary

As described above, with the cloud printing system 1 (see FIG. 1) according to the present exemplary embodiment, a job stored in the printer 20 (see FIG. 1) designated as the push printing execution apparatus may be deleted by an operation on the user terminal 30 (see FIG. 1). Thus, the printer 20 designated as the execution apparatus needs not to be operated for deleting a push printing job.

With this arrangement, the user does not need to access the printer 20 designated as the execution apparatus just to delete a push printing job. That is, a load for deleting a push printing job that is unlikely to be executed from the printer 20 is reduced.

Thus, a reduction in the number and data size of jobs that are stored in the printer 20 while being unlikely to be executed is facilitated. As a result, the storage area of the printer 20 that can be used to provide services can be increased compared with conventional systems.

### Second Exemplary Embodiment

Also in the present exemplary embodiment, the cloud printing system 1 (see FIG. 1) described in the first exemplary embodiment is used.

Also in the present exemplary embodiment, the processing sequence described with reference to FIG. 5 (i.e., the registration sequence for push printing) is executed.

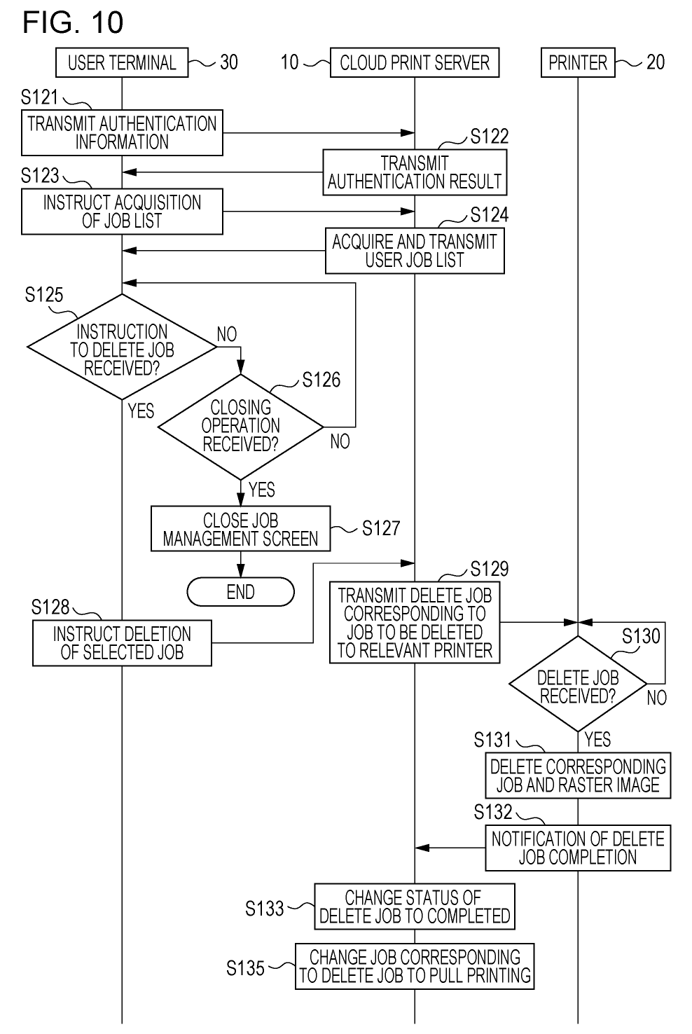

FIG. 10 is a diagram illustrating an exemplary processing sequence after registration of push printing according to the second exemplary embodiment. In FIG. 10, parts corresponding to those in FIG. 6 are denoted by the same reference numerals.

In the case of the processing sequence illustrated in FIG. 10, after execution of step 133, the cloud print server 10 changes the job corresponding to the delete job to pull printing (step 135). That is, a job registered as a push printing job is changed to a pull printing job. As a result, the user can execute pull printing by using any printer 20 that he/she has accessed without re-registering the job.

With the present exemplary embodiment as well, a job that has been changed to pull printing might be left unexecuted. Still, a pull printing job is stored in the cloud print server 10 and is not transmitted to the printer 20 until an output operation is received from a user. Compared with the storage capacity of the printer 20, the cloud print server 10 has an extra storage capacity. Thus, adverse effects due to jobs being left in the cloud print server 10 can be reduced from a case where a job remains in the printer 20.

Additionally, for a pull printing job, a mechanism that allows for the instruction to delete the pull printing job from the job list may be employed. With this mechanism, a pull printing job that is unlikely to be executed can be deleted from the user terminal 30 at any time. For receiving the deletion instruction, a delete button or the like may be provided, as in the case of push printing.

### Third Exemplary Embodiment

Also in the present exemplary embodiment, the cloud printing system 1 (see FIG. 1) described in the first exemplary embodiment is used.

Also in the present exemplary embodiment, the processing sequence described with reference to FIG. 5 (i.e., the registration sequence for push printing) is executed.

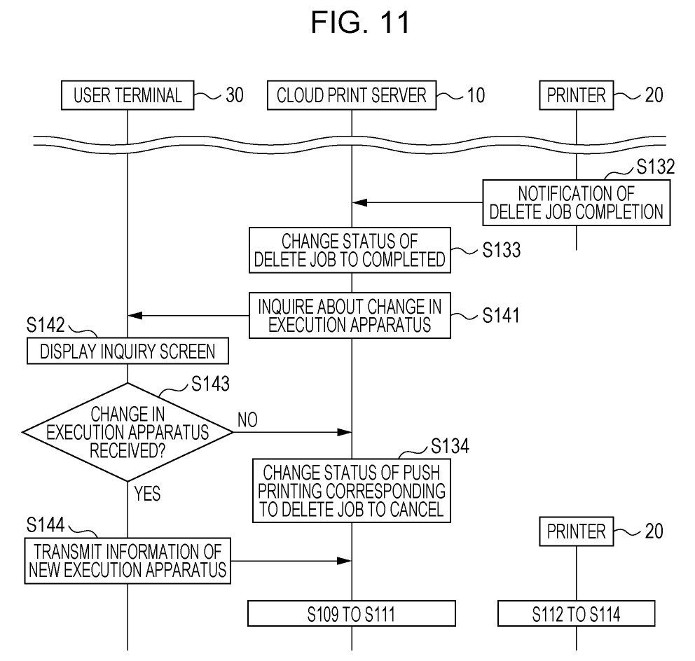

FIG. 11 is a diagram illustrating an exemplary processing sequence after registration of push printing according to the third exemplary embodiment. In FIG. 11, parts corresponding to those in FIG. 6 are denoted by the same reference numerals.

In the case of the processing sequence illustrated in FIG. 11, after execution of step 133, the cloud print server 10 inquires of the user terminal 30 corresponding to the deleted job about a change in execution apparatus (step 141). That is, in the present exemplary embodiment, while maintaining the push printing job, the user is inquired whether he/she wants to change the execution apparatus.

Upon receiving the inquiry, the user terminal 30 displays an inquiry screen (step 142). The inquiry screen displays, for example, "Do you want to designate another printer as an execution apparatus?" "If yes, please designate a new execution apparatus" and "If no, delete the job". It is a matter of course that these phrases are merely examples.

Thereafter, the user terminal 30 determines whether a change in execution apparatus has been received (step 143).

When a change in execution apparatus is not received, a negative result is obtained in step 143. In this case, the user terminal 30 notifies the cloud print server 10 of such a fact. In this case, the cloud print server 10 changes the status of push printing corresponding to the delete job to cancel (step 134). As in the second exemplary embodiment, step 135 (see FIG. 10) may be executed instead of step 134.

On the other hand, when a change in execution apparatus is received, a positive result is obtained in step 143. In this case, the user terminal 30 transmits information on the new execution apparatus to the cloud print server 10 (step 144).

Thereafter, the cloud print server 10 executes steps 109 to 111, and the printer 20 newly designated as the execution apparatus executes steps 112 to 114. That is, when a new execution apparatus is designated, a new delete job is generated.

Thus, when the newly designated execution apparatus cannot execute a print job, a push printing job stored in the relevant printer 20 can be deleted from a remote location.

With the mechanism according to the present exemplary embodiment, it is possible to reduce the load on the user when the user wishes to change the execution apparatus for push printing. That is, it is only necessary to designate a new execution apparatus, and a job needs not to be re-registered.

### Fourth Exemplary Embodiment

Also in the present exemplary embodiment, the cloud printing system 1 (see FIG. 1) described in the first exemplary embodiment is used.

Also in the present exemplary embodiment, the processing sequence described with reference to FIG. 5 (i.e., the registration sequence for push printing) is executed.

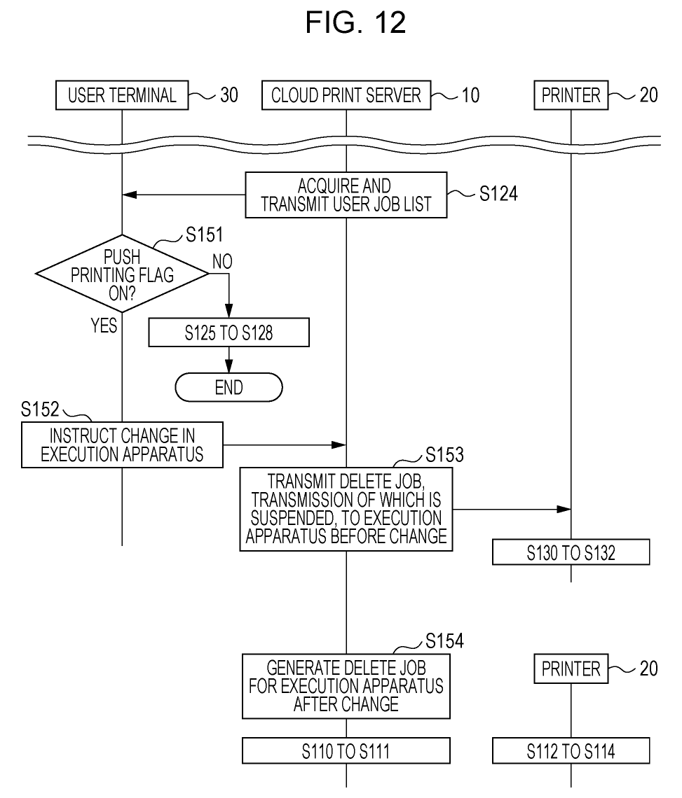

FIG. 12 is a diagram illustrating an exemplary processing sequence after registration of push printing according to the fourth exemplary embodiment. In FIG. 12, parts corresponding to those in FIG. 6 are denoted by the same reference numerals.

In the processing sequence illustrated in FIG. 12, for example, the pull-down menu 303B (see FIG. 8) of the job management screen 310 (see FIG. 8) is assumed to be provided with an item for instructing a change in execution apparatus.

In the case of FIG. 12, while the job management screen 310 is displayed, the user terminal 30 determines whether a change in execution apparatus has been received (step 151).

When the received operation is not for changing the execution apparatus, a negative result is obtained in step 151. In this case, the same process as that of the first exemplary embodiment is executed. Specifically, it is determined whether a job deletion instruction is received (step 125), and a process corresponding to the determination result is executed.

On the other hand, when an instruction to change the execution apparatus is issued, a positive result is obtained in step 151. In this case, the user terminal 30 instructs the cloud print server 10 to change the execution apparatus (step 152).

The cloud print server 10 transmits the delete job, the transmission of which is suspended, to the execution apparatus before the change (step 153).

With the printer 20 corresponding to the execution apparatus before the change, the same process as that in the first exemplary embodiment is executed. Specifically, step 130 to step 132 are executed.

After step 153 is executed, the cloud print server 10 generates a delete job for the execution apparatus after the change (that is, the new transmission destination) (step 154). Thus, when the printer 20 after the change cannot execute the print job, the print job stored in the printer 20 can be canceled from a remote location.

Then, the cloud print server 10 executes the same process as in the first exemplary embodiment. Specifically, step 110 to step 111 are executed.

When the mechanism described in the present exemplary embodiment is employed, the user can issue an instruction to change the execution apparatus for push printing without issuing an instruction to delete push printing.

### Other Exemplary Embodiments

(1) Although the exemplary embodiments of the present disclosure have been described above, the technical scope of the present disclosure is not limited to the scope of the above-described exemplary embodiments. It is apparent from the claims that various changes in and improvements to the above-described exemplary embodiments are also included in the technical scope of the present disclosure.

(2) In the exemplary embodiments described above, each process is executed by any computer. Any computer may perform the processes by using a processor serving as hardware, a program serving as software, or a combination of these.

In this case, the processor is configured to perform various processes in the exemplary embodiments in cooperation with the program and may function as a unit or a means in the exemplary embodiments.

The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU).

Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of the exemplary embodiments, the order in which the processor performs the processes is not limited to the order described above and may be changed appropriately. The hardware is composed of electric circuitry in which circuit elements such as semiconductor elements are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (such as, for example, a storage medium or another storage).

The program may be stored in such a divided manner in multiple non-transitory computer readable media present in apparatuses physically away from each other. The program code or the code segments may represent a procedure, a function, a sub program, a routine, a subroutine, a module, a software package, a class, or any combination of instructions, data structures, or program statements. The program code or the code segments may be connected to another code segment or a hardware circuit by transmitting and/or receiving information, data, an argument, a parameter, or memory content.

(3) The present disclosure can also be applied to a program and a program product.

### Appendix

(((1)))

An information processing system comprising a processor configured to: receive, from a user terminal, an instruction to delete a job transmitted to an image forming apparatus through a cloud-type print service; and instruct the image forming apparatus serving as a transmission destination of the job to delete the job and image data generated based on the job that are stored in the image forming apparatus.

(((2)))

The information processing system according to (((1))), wherein the job includes information for instructing the image forming apparatus to generate the image data before a notification of successful authentication is received and to store the generated image data.

(((3)))

The information processing system according to (((2))), wherein the image forming apparatus starts to form an image based on the image data in response to the notification of successful authentication.

(((4)))

The information processing system according to any one of (((1))) to (((3))), wherein the user terminal displays a management screen for the cloud-type print service, the management screen including an operator with which an instruction to delete the job is issued.

(((5)))

The information processing system according to (((4))), wherein the operator is displayed as one of menus related to the job.

(((6)))

The information processing system according to any one of (((1))) to (((5))), wherein when the processor receives the instruction to delete the job, the processor is configured to transmit a delete job instructing deletion of the job to the image forming apparatus.

(((7)))

The information processing system according to (((6))), wherein the processor is configured to generate the delete job paired with the job upon receiving the job, and suspend the transmission of the delete job to the image forming apparatus until the processor receives the deletion of the job.

(((8)))

The information processing system according to any one of (((1))) to (((7))), wherein when the processor receives a notification of deletion of the job and the image data from the image forming apparatus, the processor is configured to delete the job from a management target of the print service.

(((9)))

The information processing system according to any one of (((1))) to (((8))), wherein when the processor receives a notification of deletion of the job and the image data from the image forming apparatus, the processor is configured to change management of the job in the print service to a job of a method in which the job is transmitted to any image forming apparatus operated by a user after successful authentication.

(((10)))

The information processing system according to any one of (((1))) to (((9))), wherein when the processor receives a notification of deletion of the job and the image data from the image forming apparatus, the processor is configured to receive designation of a new transmission destination of the job through the print service.

(((11)))

A program causing a computer to execute a process for information processing, the process comprising: receiving, from a user terminal, an instruction to delete a job transmitted to an image forming apparatus through a cloud-type print service; and instructing the image forming apparatus serving as a transmission destination of the job to delete the job and image data generated based on the job that are stored in the image forming apparatus.

What is claimed is:

1. An information processing system comprising:
a processor configured to:
receive, from a user terminal, an instruction to delete a job transmitted to an image forming apparatus through a cloud-type print service; and
instruct the image forming apparatus serving as a transmission destination of the job to delete the job and image data generated based on the job that are stored in the image forming apparatus.

2. The information processing system according to claim 1, wherein the job includes information for instructing the image forming apparatus to generate the image data before a notification of successful authentication is received and to store the generated image data.

3. The information processing system according to claim 2, wherein the image forming apparatus starts to form an image based on the image data in response to the notification of successful authentication.

4. The information processing system according to claim 1, wherein the user terminal displays a management screen for the cloud-type print service, the management screen including an operator with which an instruction to delete the job is issued.

5. The information processing system according to claim 4, wherein the operator is displayed as one of menus related to the job.

6. The information processing system according to claim 1, wherein
when the processor receives the instruction to delete the job, the processor is configured to transmit a delete job instructing deletion of the job to the image forming apparatus.

7. The information processing system according to claim 6, wherein the processor is configured to:
generate the delete job paired with the job upon receiving the job; and
suspend the transmission of the delete job to the image forming apparatus until the processor receives the deletion of the job.

8. The information processing system according to claim 1, wherein
when the processor receives a notification of deletion of the job and the image data from the image forming apparatus, the processor is configured to delete the job from a management target of the print service.

9. The information processing system according to claim 1, wherein
when the processor receives a notification of deletion of the job and the image data from the image forming apparatus, the processor is configured to change management of the job in the print service to a job of a method in which the job is transmitted to any image forming apparatus operated by a user after successful authentication.

10. The information processing system according to claim 1, wherein
when the processor receives a notification of deletion of the job and the image data from the image forming apparatus, the processor is configured to receive designation of a new transmission destination of the job through the print service.

11. A non-transitory computer readable medium storing a program causing a computer to execute a process for information processing, the process comprising:
receiving, from a user terminal, an instruction to delete a job transmitted to an image forming apparatus through a cloud-type print service; and
instructing the image forming apparatus serving as a transmission destination of the job to delete the job and image data generated based on the job that are stored in the image forming apparatus.
